(19) United States
(12) Patent Application Publication
(10) Pub. No.: US 2014/0363131 A1
(43) Pub. Date: Dec. 11, 2014

(54) OPTICAL BACKPLANE SYSTEM

(71) Applicant: HON HAI PRECISION INDUSTRY CO., LTD., New Taipei (TW)

(72) Inventor: JAMES M. SABO, Marysville, PA (US)

(21) Appl. No.: 13/912,131

(22) Filed: Jun. 6, 2013

(51) Int. Cl. G02B 6/42

(52) U.S. Cl. CPC G02B 6/4257
USPC 385/89

(57) ABSTRACT

An optical backplane system (600) comprising a horizontal backplane (30), a coupler (33) assembled to the backplane, a card assembly (100), and a connector assembly (500). The horizontal backplane defines a number of positioning holes (306). The coupler defines a number of upward openings (320) and a corresponding number of downward openings (340) upwardly communicating corresponding upward openings through the positioning holes. The card assembly has a number of first optical plugs (26). The connector assembly has a number of second optical plugs (46). When the card assembly and the connector assembly are mounted onto the backplane, the first and second optical plugs are inserted into corresponding openings of the coupler, so that the first optical plug are optically communicated with corresponding second optical plugs.

### CROSS-REFERENCE TO RELATED APPLICATIONS

This patent application is related to a pending U.S. patent application Ser. No. 12/960,590, filed on Dec. 6, 2010, and entitled “CONNECTOR ASSEMBLY WITH IMPROVED STRUCTURE ON A BRACKET FOR MOUNTING CONNECTORS,” which is assigned to the same assignee with this application.

### BACKGROUND OF THE INVENTION

1. Field of the Invention

The present invention relates to an optical backplane system.

2. Description of Related Art

In a large system, such as a telecommunication system, it is common to enclose components, such as Printed Circuit Boards (PCBs), blades, or nodes, constituting the system inside a chassis. The chassis allows designing scalable systems, i.e., systems into which additional components can be added. In order to allow the different components to communicate between them, each component is connected to a backplane. A backplane is typically a PCB having slots into which other components such as PCBs, blades or cards, are plugged, and is typically just a connector without active surface mounted devices on it.

Optical communication has a trend to replace electrical communication, and this trend applied to the backplane system. U.S. Pat. No. 6,819,855 discloses such an optical backplane system. There is disclosed a backplane housing combined with a printed board housing to constitute a coupler for coupling two optical plugs inserted therein. Also disclosed is a clip for munting the backplane housing. The backplane housing is composed of a prismatic housing main body and an internal housing housed in an internal space penetrating the housing main body by inserting it into the internal space from a surface abutting against the backplane. The internal housing is engaged with the housing main body by pawls and projections. The present invention is aimed to provide an optical backplane system and an optical card assembly having simplified structure.

### SUMMARY OF THE INVENTION

Accordingly, an object of the present invention is to provide an optical backplane system with less optical attenuation and easing assembly. The optical backplane system comprises a horizontal backplane, a coupler assembled to the backplane, a card assembly, and a connector assembly. The horizontal backplane defines an upward main face, a downward main face opposite to the upward main face, and a plurality of positioning holes lined in a longitudinal direction and each vertically extending through the upward and the downward main faces. The coupler has a first portion defining a plurality of upward openings lined in a horizontally longitudinal direction and a second portion defining a plurality of downward openings. The downward openings are respectively communicated upwardly to corresponding upward openings through the positioning holes of the backplane. The card assembly has a card quipped with a plurality of first optical plugs downwardly insertable into the corresponding upward openings of the coupler, each of the first optical plugs having a plurality of first optical waveguides. The connector assembly has a plurality of second optical plugs upwardly insertable into the corresponding downward openings of the coupler, each of the second optical plugs having a plurality of second optical waveguides. When the card and the connector assembly are mounted onto the backplane, the first optical plugs and the second optical plugs are inserted into corresponding openings of the coupler, and the first optical waveguides are aligned with corresponding second optical waveguides.

Other objects, advantages and novel features of the invention will become more apparent from the following detailed description when taken in conjunction with the accompanying drawings.

### BRIEF DESCRIPTION OF THE DRAWINGS

FIG. 1 is an optical backplane system according to an embodiment of the present invention with some of optical plugs removed.

FIG. 2 is a view of the FIG. 1 except from a different view point.

FIG. 3 is a partially exploded view of the optical backplane system.

FIG. 4 is a view of the FIG. 3 except from a different view point.

FIG. 5 is an exploded view of a card assembly shown in FIG. 3 with the card is removed.

FIG. 6 is a view of FIG. 5 except from a different view point.

FIG. 7 is a cross-section view along a line 7-7 as shown in FIG. 2 with the card removed.

FIG. 8 is a cross-section view along a line 8-8 as shown in FIG. 2.

### DETAILED DESCRIPTION OF THE PREFERRED EMBODIMENT

Reference will now be made in detail to the preferred embodiment of the present invention.

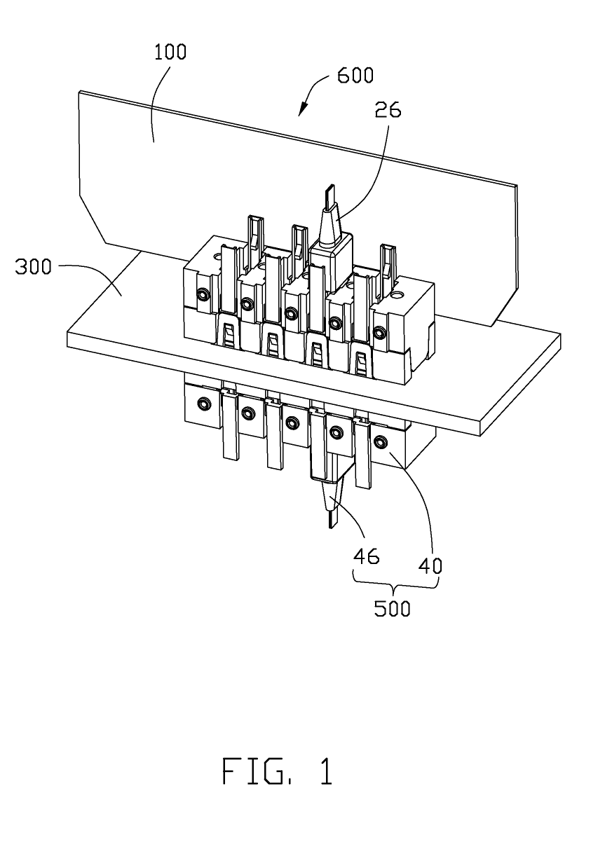

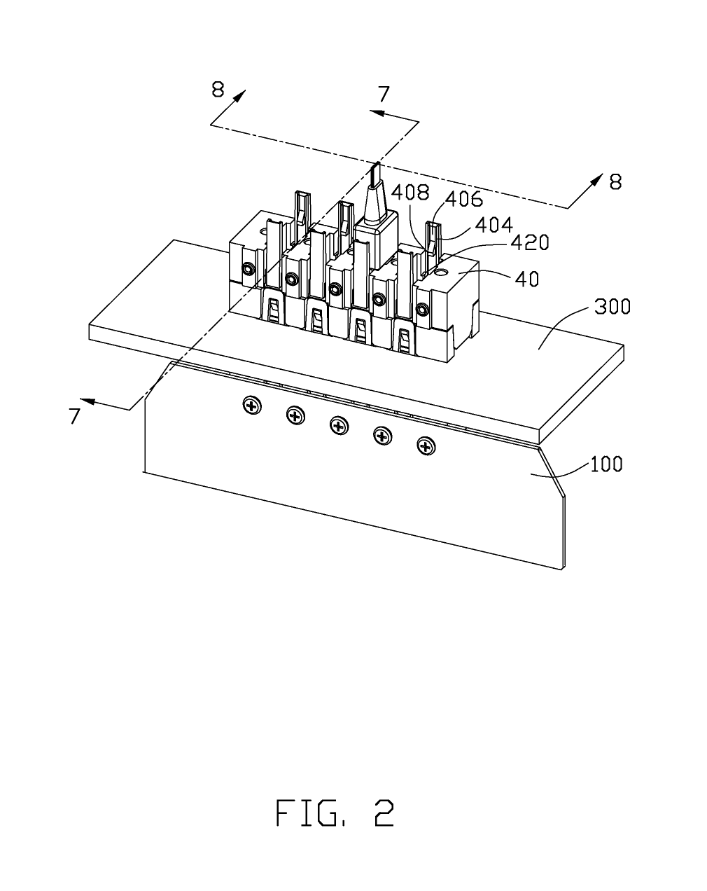

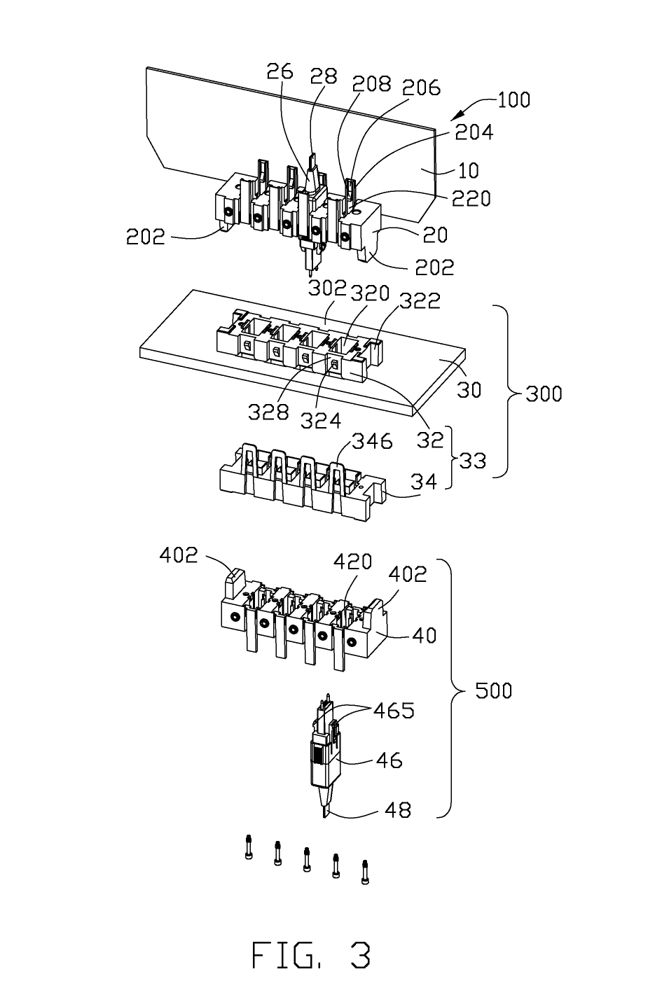

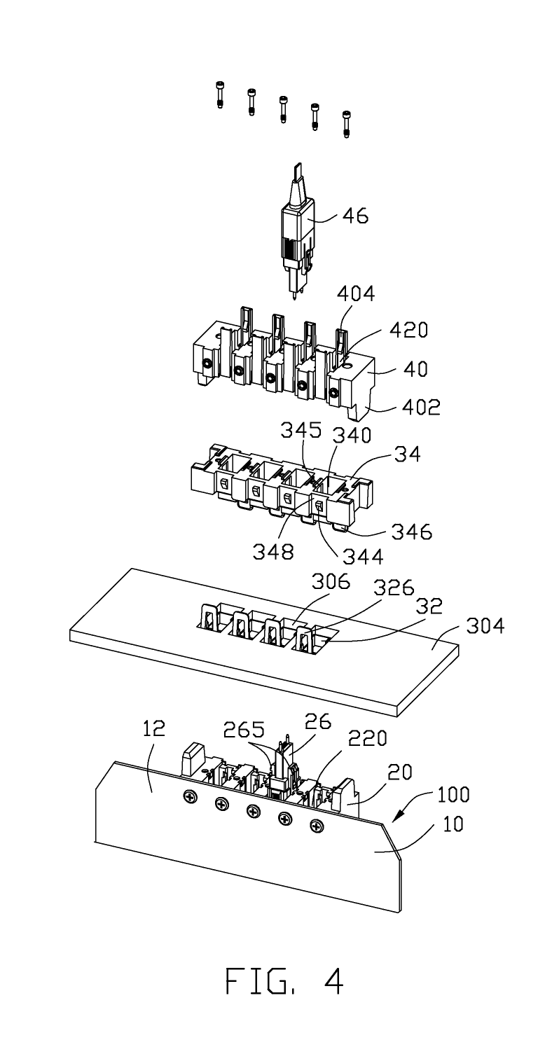

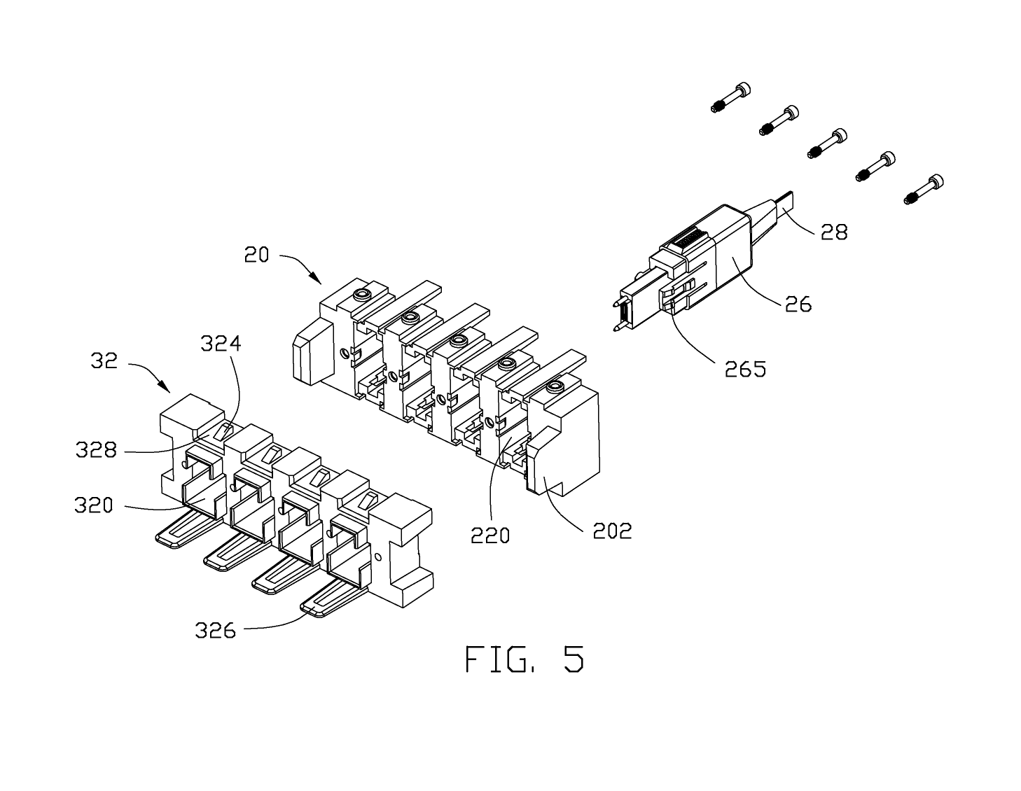

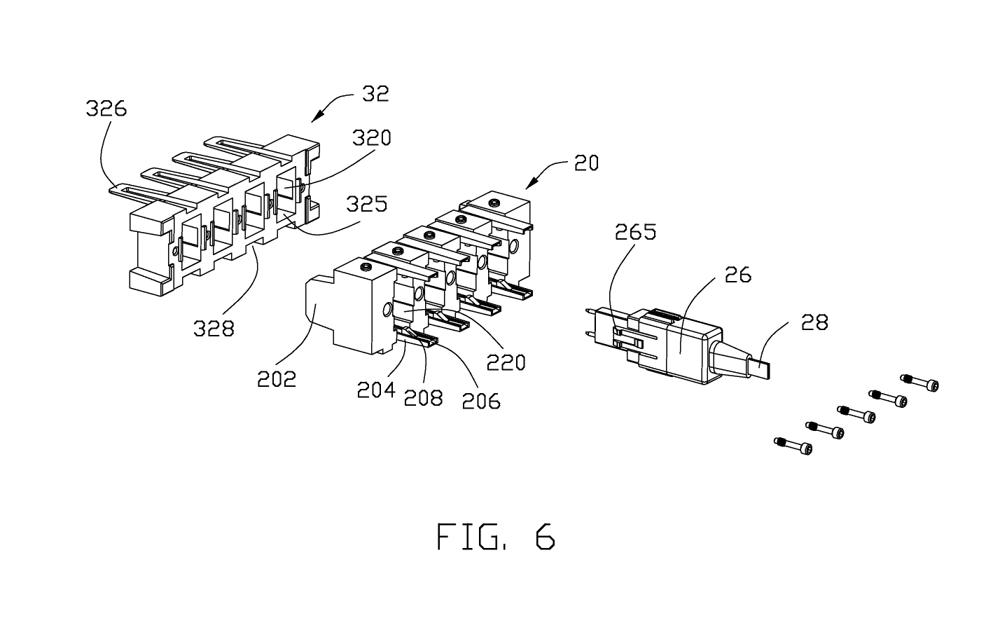

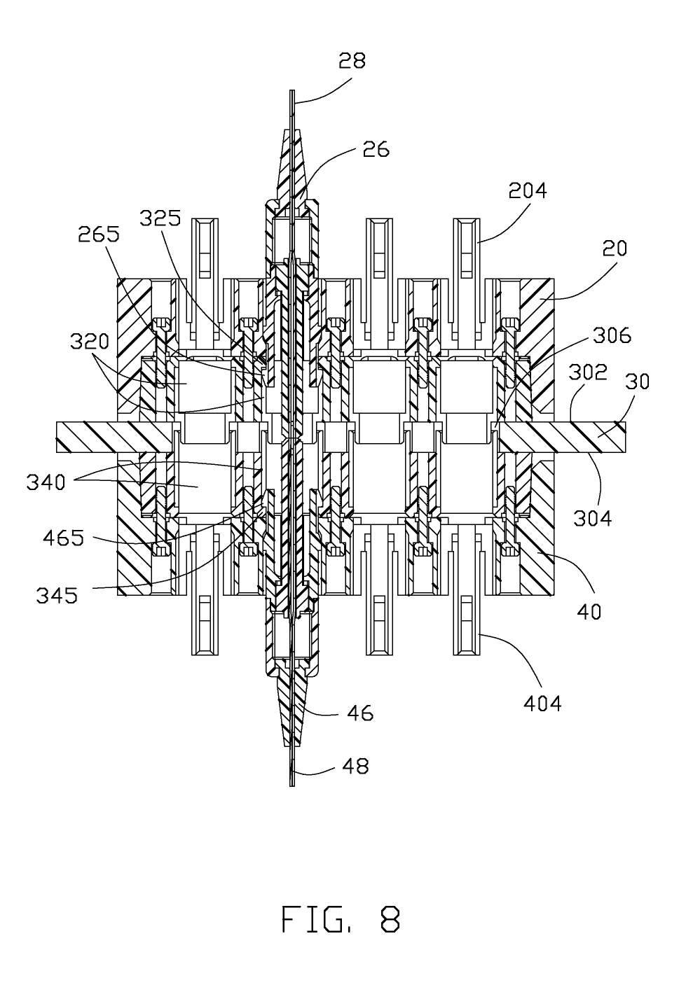

Referring FIGS. 1-8, an optical backplane system 600 comprises a backplane assembly 300, an upper optical card assembly 100, and a lower optical connector assembly 500.

The backplane assembly 300 includes a horizontal backplane 30 and a coupler 33 mounted to the backplane 30. The backplane 30 defines an upward main face 302, a downward main face 304 opposite to the upward main face 302, and an array of positioning holes 306 each vertically extending through the upward and the downward main faces 302, 304. There are only one row of the positioning holes 306 lined in a longitudinal direction shown in the Figures and the other rows are removed for clearly shown. The coupler 33 has a first portion 32 disposed on the upward main face 302 of the backplane 30 and a second portion 34 disposed on the downward main face 304. The first portion 32 defines a row of upward openings 320 opening upwardly and lined in the longitudinal direction. The second portion 34 defines a plurality of downward openings 340 communicating upwardly the upward opening 320 through the positioning holes 306 of the backplane 30.

The first portion 32 and the second portion 34 of the coupler 33 are molded separately. The first portion 32 is downwardly mounted onto the upward main face 302 of the backplane 30. The first portion 32 and the second portion 34 of the coupler 33 form latching means snappingly locked with each other. The first portion 32 has a first side face (not labeled) and a second side face (not labeled) transversely opposite to each other. The first portion 32 defines a plurality of vertical slots 328 in the first side face and forms a plurality of downwardly extending latching arms 326 in the second side face. The vertical slots 328 and the latching arms 326 are aligned to corresponding openings 320 of the first portion 32 in the transverse direction. Each of the vertical slots 328 has a latching block 324 laterally protruding from a bottom floor thereof

The second portion 34 is upwardly mounted onto the downward main face 304 of the backplane 30. The second portion 34 has a first side face (not labeled) and a second side face (not labeled) transversely opposite to each other. The second portion 34 defines a plurality of vertical slots 348 in the first side face and forms a plurality of upwardly extending latching arms 346 in the second side face. The vertical slots 348 and the latching arms 346 are aligned to corresponding openings 340 of the second portion 34 in the transverse direction. Each of the vertical slots 348 has a latching block 344 laterally protruding from a bottom floor thereof In order to cut cost down, the structure of the second portion 34 is quite the same as the structure of the first portion 32 so that a same mold could be used to mold the first and the second portion 32, 34. When the first portion 32 and the second portion 34 is centrosymmetrically mounted onto the backplane 30, the latching arms 326 of the first portion 32 are guided into the slots 348 of the second portion 34 and locked with the blocks 344 thereof, while the latching arms 346 of the second portion 34 are guided into the slots 328 of the first portion 32 and locked with the blocks 324 thereof, thereby forming the latching means and locking the first portion 32 and second portion 34 together with the backplane 30 sandwiched therebetween.

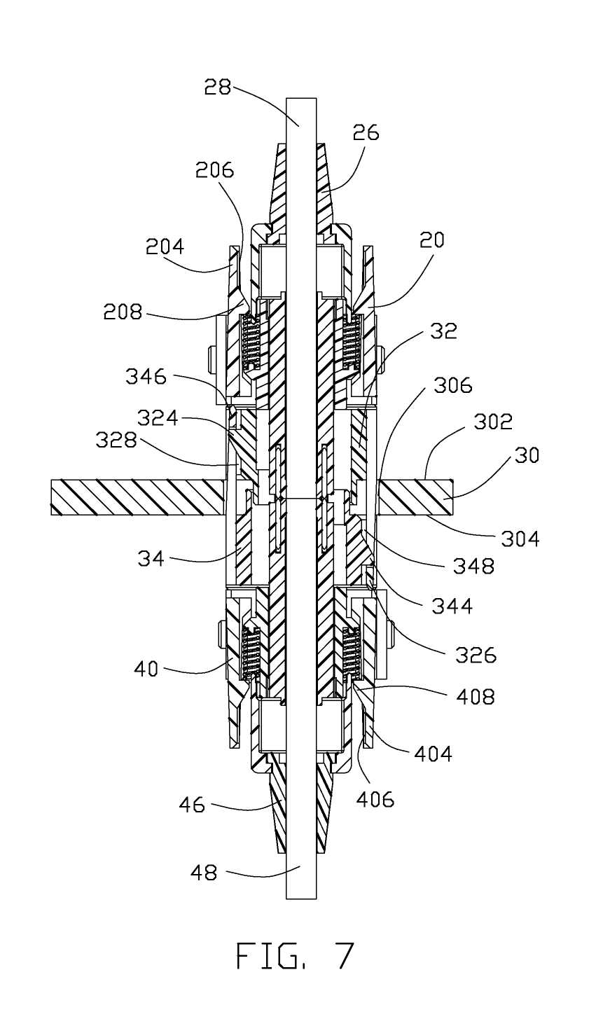

The upper optical card assembly 100 includes a card 10 loaded with a plurality of O/E components (not shown), an upper holder 20 screwed to the card 10 and a plurality of first optical plug 26 secured by the upper holder 20. The card 10 has a lower edge 12 extending in the longitudinal direction. The upper holder 20 defines a plurality of holding holes 220 arrayed along the lower edge 12 of the card 10. Each of the first optical plugs 26 is respectively into one of the holding holes 220 and secured therein. The upper holder 20 further forms plural pairs of guiding rails 204. The two guiding rails 204 of each pair are disposed on transversely opposite sides of corresponding holding holes 220 and each defines a guiding slot 206 in an inner side thereof to guide the insertion of the first optical plug 26. Each of the guiding rails 204 forms a latching block 208 in the guiding slot 206 for snap-mating with the first optical plug 26 inserted therein. The first optical plug 26 has a spring (shown in FIG. 7, not labeled) upwardly abutting the latching block 208 and giving the first optical plug 26 a downwardly pressing force when the latching block 208 was snap-mated with the first optical plug 26. Each of the first optical plugs 26 has a plurality of optical waveguides 28 communicating with the plural O/E components on the card 10. The optical waveguides 28 are formed of polymer, the polymer waveguides including a core layer having plural optical channels arrayed in the transverse direction and a cladding layer coating the core layer.

The lower optical connector assembly 500 includes a lower holder 40 and a plurality of second optical plugs 46 secured by the lower holder 40. The lower holder 40 defines a plurality of holding holes 420 arrayed along the longitudinal direction. Each of the second optical plugs 46 is respectively inserted into one of the holding holes 420 and secured therein. The lower holder 40 further forms plural pairs of guiding rails 404. The two guiding arms 404 of each pair are disposed on transversely opposite sides of corresponding holding holes 420 and each defines a guiding slot 406 in an inner side thereof to guide the insertion of the second optical plug 46. Each of the guiding rails 404 forms a latching block 408 in the guiding slot 406 for snap-mating with the second optical plug 46 inserted therein. The second optical plug 46 has a spring (shown in FIG. 7, not labeled) upwardly abutting the latching block 408 and giving the first optical plug 26 an upwardly pressing force when the latching block 208 was snap-mated with the first optical plug 26. Each of the second optical plugs 46 has a plurality of optical waveguides 48 for carrying optical signals. The optical waveguides 48 are formed of polymer, the polymer waveguides including a core layer having plural optical channels arrayed in the transverse direction and a cladding layer coating the core layer. It is quite understandable for a technician in the art that the connector assembly 500 could be mounted onto another card having O/E components coupled to the optical waveguides 48.

The holding holes 220, 420 of the upper holder 20 and the lower holder 40 are arranged in such way that when the upper and lower optical card assemblies 100, 500 are assembled to the backplane assembly 300, each of the first and second optical plugs 26, 46 is mated into the corresponding upper and lower openings 320, 340 of the coupler 33, and furthermore, the optical waveguides 48 are aligned to the optical waveguides 28 so that the lower optical card assembly 500 is optically communicated with the upper optical card assembly 100. The upper holder 20 has guiding means, two downwardly protruding guiding posts 202 disposed at longitudinally opposite ends thereof, for mating with the first portion 32 of the coupler 33 when the card assembly 100 are mounted onto the backplane assembly 300. The lower holder 40 has guiding means, two downwardly protruding guiding posts 402 disposed at longitudinally opposite ends thereof, for mating with the second portion 34 of the coupler 33 when the lower connector assembly 500 are mounted onto the backplane assembly 300.

Each of the first and the second optical plugs 26, 46 forms a pair of latching arms 265, 465 disposed on opposite sides thereof in said longitudinal direction, the latching arms 265, 465 engaging steps 325, 345 formed in the openings 320, 340 of the coupler 33.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical backplane system comprising:
a horizontal backplane defining an upward main face, a downward main face opposite to the upward main face, and a plurality of positioning holes lined in a longitudinal direction and each vertically extending through the upward and the downward main faces;
a coupler assembled to the backplane, the coupler having a first portion defining a plurality of upward openings lined in a horizontally longitudinal direction and a second portion defining a plurality of downward openings, the downward openings respectively communicated upwardly to corresponding upward openings through the positioning holes of the backplane;
a card assembly having a card equipped with a plurality of first optical plugs downwardly insertable into the corresponding upward openings of the coupler, each of the first optical plugs having a plurality of first optical waveguides; and
a connector assembly equipped with a plurality of second optical plugs upwardly insertable into the corresponding downward openings of the coupler, each of the second optical plugs having a plurality of second optical waveguides; wherein
when the card assembly and the connector assembly are mounted onto the backplane, the first optical plugs and the second optical plugs are inserted into corresponding openings of the coupler, and the first optical waveguides are aligned with corresponding second optical waveguides; and wherein
the first portion and the second portion of the coupler are separately molded with a same configuration and centrosymmetrically mounted onto the upward and the downward main faces of the backplane.

2. The optical backplane system claimed in claim 1, wherein the first portion and the second portion of the coupler form latching means snappingly locked with each other.

3. The optical backplane system claimed in claim 1, wherein the first portion and the second portion form plural sets of latching means each including a latching arm and a block respectively disposed on transversely opposite sides of the openings, the latching arms of the first portion engaging corresponding latching blocks of the second portion, the latching blocks of the second portion engaging corresponding latching arms of the second portion.

4. The optical backplane system claimed in claim 1, further comprising:
an upper holder fixed to the card and defining a plurality of holding holes each securing one of the first optical plugs, and
a lower holder defining a plurality of holding holes each securing one of the second optical plugs.

5. The optical backplane system claimed in claim 4, wherein the upper holder has guiding means mating with the first portion of the coupler when the card assembly is mounted onto the backplane, and the lower holder has guiding means mating with the second portion of the coupler when the connector assembly is mounted onto the backplane.

6. The optical backplane system claimed in claim 5, wherein the upper holder is screwed to the first portion of the coupler and the lower holder is screwed to the second portion of the coupler.

7. The optical backplane system claimed in claim 4, wherein the upper holder has plural pairs of guiding rails, two guiding rails of each pair being disposed on transversely opposite sides of the holding holes and each defining a guiding slot mating with a corresponding first optical plug.

8. The optical backplane system claimed in claim 4, wherein the upper holder and the lower holder have a same configuration.

9. The optical backplane system claimed in claim 1, wherein each of the first and the second optical plugs forms a pair of latching arms on opposite sides thereof in said longitudinal direction, the latching arms engaging with steps formed in the openings of the coupler.

10. The optical backplane system claimed in claim 1, wherein the optical waveguides are formed of polymer and each includes a core layer having plural optical channels arrayed transversely and a cladding layer coating the core layer.

11. An optical card assembly, adapted to mate with a backplane assembly having a horizontal backplane and a coupler mounted thereon, the coupler defining a plurality of upward openings, the optical card assembly comprising:
a vertical card having a lower edge,
a holder fixed to the lower edge of the card and defining a plurality of holding holes vertically extending therethrough, the holding holes aligned in a longitudinal direction along the lower edge;
a plurality of optical plugs each downwardly inserted into corresponding holding holes, each of the optical plugs having at least one optical waveguide secured therein; wherein
a plurality of springs each applies a downward force to a corresponding optical plug and an upward force to the holder.

12. The optical card assembly claimed in claim 11, wherein the holder comprises plural pairs of guiding rails, two guiding rails of each pair being disposed on transversely opposite sides of corresponding holding holes to guide the insertion of the optical plug.

13. The optical card assembly claimed in claim 12, wherein each of the guiding rails forms a latching block for snap-mating with the optical plug inserted therein.

14. The optical card assembly claimed in claim 13, wherein each of the springs is fixed within a corresponding one of the optical plugs and has one end upwardly abutting the latching block to downwardly press the first optical plug when the latching block is snap-mated with the optical plug.

15. The optical card assembly claimed in claim 11, wherein said at least one polymer waveguide includes a core layer having plural optical channels arrayed in a transverse direction perpendicular to the longitudinal direction and a cladding layer coating the core layer.

16. The optical card assembly claimed in claim 11, wherein each of the optical plugs has a pair of latching arms disposed on opposite sides thereof in the longitudinal direction for locking the optical plugs to the coupler.
